(19) United States
(12) Patent Application Publication
(10) Pub. No.: US 2020/0359774 A1
(43) Pub. Date: Nov. 19, 2020

(54) PORTABLE DEVICE HOLDER

(71) Applicant: Cassie-ann Caine, Toronto (CA)

(72) Inventor: Cassie-ann Caine, Toronto (CA)

(21) Appl. No.: 16/414,031

(22) Filed: May 16, 2019

(51) Int. Cl. A45F 5/00; F16M 11/04; F16M 11/20

(52) U.S. Cl. CPC A45F 5/00; F16M 11/04; A45F 2200/0525; A45F 2005/008; A45F 2200/0516; F16M 11/20

(57) ABSTRACT

The present invention relates to a portable holder for an electronic device, comprising: a body brace, the body brace formed to a contour of a human appendage, and including straps to secure the body brace to the human appendage; an extension arm, the extension arm telescopically moveable from a collapsed position to a fully extended position; a device holder, the device holder provide a removably secure support for the electronic device a first rotatable joint coupling the extension arm to the body brace and providing a degree of motion between the extension arm and the body brace; and a second rotatable joint coupling the extension arm to the device holder and providing a degree of motion between the extension arm and the device holder, wherein the body brace is removably securable to a human appendage.

### FIELD OF THE INVENTION

The present specification relates generally to holders for electronic devices, and more particularly to a holder for a phone or tablet device which is secured to a human body appendage.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

A portable electronic device (phone, tablets, e-readers) are in common and widespread use. An issue that arise is the need for the user to hold the device in one of two hands for viewing. A variety of mounts and holders have been proposed to alleviate this issue.

However, the majority of these mounts require an existing surface to which the mount is secured, rending it unusable if no such surface is available. Another potential problem is the limit viewing position provided by the mount, either through restrictions on the mount itself, or imposed by the surface requirements for mounting.

Thus, while there are attempts known in the art to provide mounts for electronic device, it would be desirable to have a mount which mitigates some of the disadvantages described above.

Accordingly, there remains a need for improvements in the art.

### SUMMARY OF THE INVENTION

In accordance with an aspect of the invention, there is provided a holder for an electronic device, and more particularly to a holder for a phone or tablet device which is secured to a human body appendage.

According to an embodiment of the invention, there is provided a portable holder for an electronic device, comprising: a body brace, the body brace formed to a contour of a human appendage, and including straps to secure the body brace to the human appendage; an extension arm, the extension arm telescopically moveable from a collapsed position to a fully extended position; a device holder, the device holder provide a removably secure support for the electronic device a first rotatable joint coupling the extension arm to the body brace and providing a degree of motion between the extension arm and the body brace; and a second rotatable joint coupling the extension arm to the device holder and providing a degree of motion between the extension arm and the device holder, wherein the body brace is removably securable to a human appendage; and wherein the portable holder holds the electronic device is a viewable position for a user when mounted in the device holder.

According to a further embodiment of the invention, there is provided a portable holder for an electronic device, comprising: a body brace, the body brace formed to a contour of a human appendage, and including straps to secure the body brace to the human appendage; an extension arm, the extension arm telescopically moveable from a collapsed position to a fully extended position; a device holder, the device holder provide a removably secure support for the electronic device a first rotatable joint coupling the extension arm to the body brace and providing a degree of motion between the extension arm and the body brace; and a second rotatable joint coupling the extension arm to the device holder and providing a degree of motion between the extension arm and the device holder, wherein the body brace is removably securable to a human appendage; and wherein the portable holder holds the electronic device is a viewable position for a user when mounted in the device holder.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a front view of a portable device holder according to an embodiment;

FIG. 2 is a top perspective view of the portable device holder of FIG. 1;

FIG. 3 is a front view a portable device holder according to an embodiment;

FIG. 4A is a front view a portable device holder according to an embodiment;

FIG. 4B is a front view of a portable device holder according to an embodiment; and

FIG. 5 is a front view of a portable device holder according to an embodiment.

Like reference numerals indicated like or corresponding elements in the drawings.

### DETAILED DESCRIPTION OF THE EMBODIMENTS

The present invention relates generally to holders for electronic devices, and more particularly to a holder for a phone or tablet device which is secured to a human body appendage.

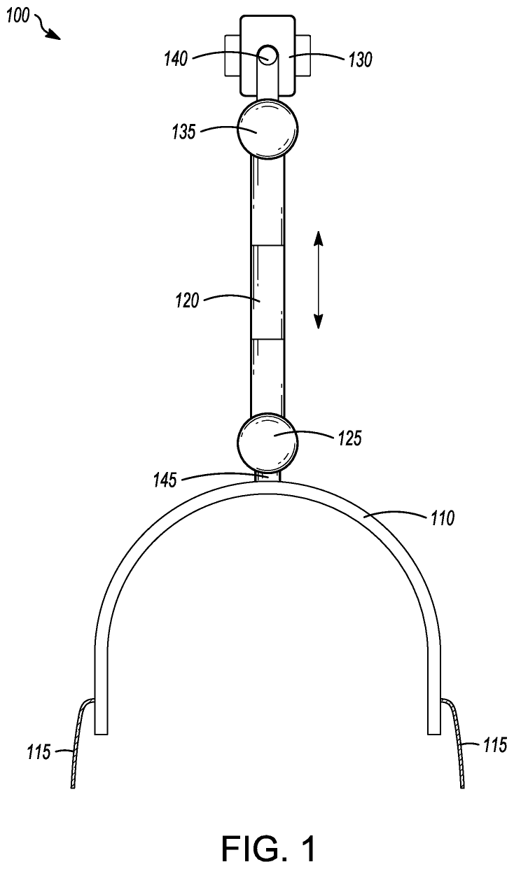

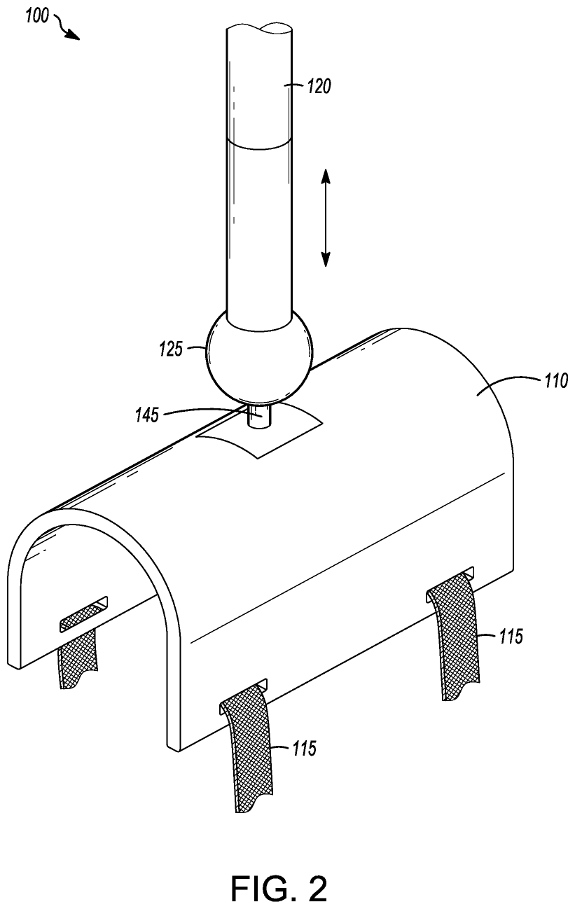

According to an embodiment as shown in FIGS. 1 and 2, a portable electronic device holder 100 includes a body brace 110, an extension arm 120 and a device holder 130. The body brace 110 is coupled to the extension arm 120 via a rotatable joint 125 (e.g. a ball joint). Similarly, extension arm 120 is coupled to device holder 130 via a rotatable joint 135. Thus, a portable electronic device (phone, tablet, GPS, etc.) may be inserted into device holder 130 and moved into a viewing position via extension arm 120 and rotatable joints 125 and 135, with support provide by body brace 110 which is secured to the user's body via a body appendage, preferably the upper leg/thigh.

Body brace 110 is preferably formed from a rigid or semi-rigid material and shaped to conform to a human appendage, such as the upper leg/thigh. Body brace 110 may further include straps 115 or an equivalent to secure body brace 110 to the appendage. Straps 115 may be fixed length, adjustable length and/or elasticized, as descried, to provide a secure and comfortable attachment to the appendage. Straps 115 may be secured togethers by snaps, magnets, hook-and-loop fasteners, buckles or other known means of attachment for straps and belts.

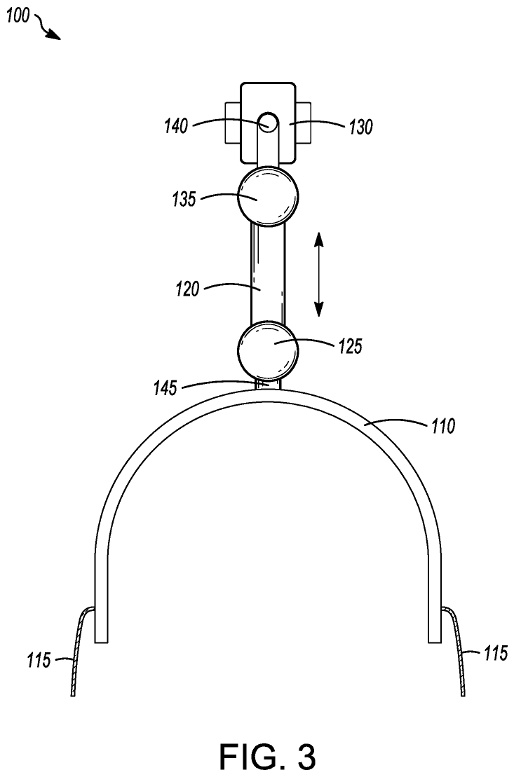

Extension arm 120 is preferably formed from a rigid, lightweight material such as plastic or aluminum. Extension arm 120 may be adjustable in length telescopically through movement of at least two pieces as shown in FIGS. 1 and 3. Once adjusted to a desired length, extension arm 120 may be locked into position using clamps, button clips, lock pins or other known locking means for telescoping arms.

Rotatable joints 125 and 135 are preferably ball joints coupled to extension arm 120. Rotatable joints 125 and 135 provide both a point of attachment and a degree of motion relative to the body brace 110 and device holder 130, respectively. Rotatable joints 125 and 135 may provide up to a 360-degree rotational motion, preferably allowing extension arm 120 to be positioned flush with body brace 110 for ease of storage and transport. Rotatable joints 125 and 135 may be locked into position using rotation clamps, friction clamps or other know locking means for rotatable joints.

Device holder 130 is designed to hold a personal electronic device, such as a phone, tablet, e-book reader or similar. Device holder 130 may be sized to a specific range of devices (e.g. phone-sized, ⅞-inch tablet sized, 10/11-inch tablet sized) with an adjustment mechanism to allow to device to be inserted and removed by the user while remaining secured to device holder 130 while inserted. Device holder 130 may include a separate mount 140 to permit modification to accommodate different devices.

In operation of portable device holder 100, the user secures the body brace 110 to their appendage preferably the upper leg/thigh using straps 115. The device is inserted into device holder 130 and secured in place. The device is then positioned for viewing view movement and extension of extension arm 120 via rotatable joints 125 and 135 and telescopic extension and retracted of extension arm 120. The device may be positioned for viewing by the user, or for another person. For example, a parent may secure portable device holder 100 to their leg and position the device so it is viewable by a nearby seated child, such as where the parent is sitting in the front seat of a vehicle and the child is in the back.

By securing portable device holder 100 to the user's leg, the need to find a separate support surface for the holder is eliminated. Additionally, the range of motion provided through extension arm 120 and rotatable joints 125 and 135 increase the range of viewing positions provided when using portable device holder 100.

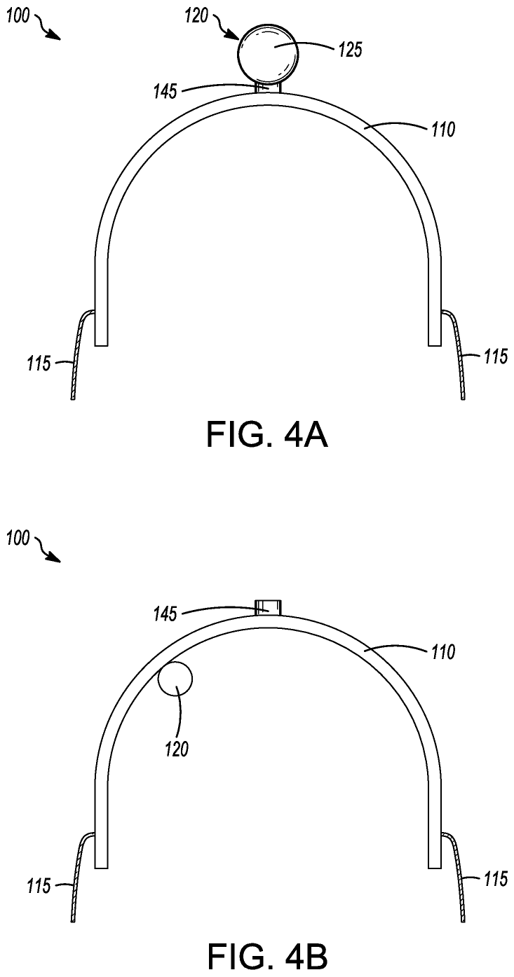

When not in use, extension arm 120 may be fully retracted and folded flush against body brace 110 to minimize the space required to store and transport portable device holder 100 as shown in FIG. 4A. Alternatively, extension arm 120 may be detachable through a coupling mechanism 145, and removed and separately secured to body brace 110 for storage as shown in FIG. 4B.

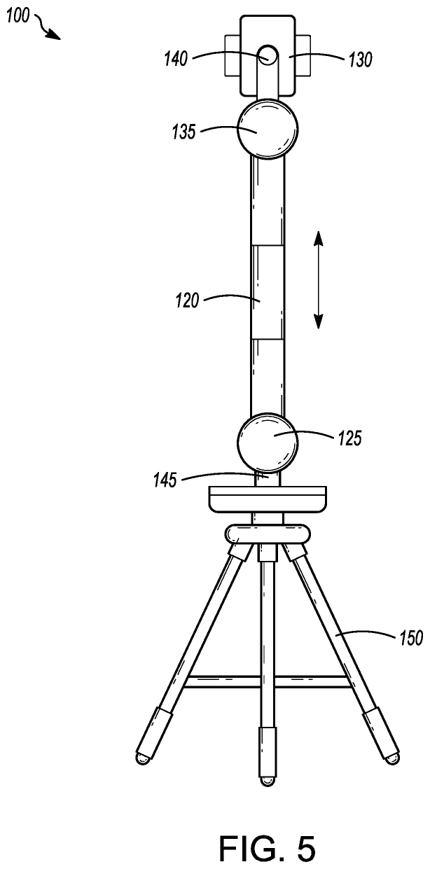

As another embodiment, as shown in FIG. 5, where extension arm 120 is detachable from the body brace, is to further include a tripod base 150 or a similar base which permits the portable device holder 100 to be placed on a flat surface (table, desk, chair, floor) for support in place of using the body brace 110 and the user's body. Tripod 150 may be separately stored or may be attached to body brace 110 for storage, similarly to storage of extension arm 120 as shown in FIG. 4B.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for insulating, protecting and installing are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A portable holder for an electronic device, comprising:
a body brace, the body brace formed to a contour of a human appendage, and including straps to secure the body brace to the human appendage;
an extension arm, the extension arm telescopically moveable from a collapsed position to a fully extended position;
a device holder, the device holder providing a removably secure support for the electronic device
a first rotatable joint coupling the extension arm to the body brace and providing a degree of motion between the extension arm and the body brace; and
a second rotatable joint coupling the extension arm to the device holder and providing a degree of motion between the extension arm and the device holder,
wherein the body brace is removably securable to a human appendage; and
wherein the portable holder holds the electronic device is a viewable position for a user when mounted in the device holder.

2. The portable holder of claim 1, wherein the human appendage is an upper leg.

3. The portable holder of claim 1, wherein the extension arm is continuously moveable from the collapsed position to the fully extended position.

4. The portable holder of claim 1, wherein the extension arm is incrementally moveable from the collapsed position to the fully extended position.

5. The portable holder of claim 1, wherein the device holder is dimensioned to hold a cellular phone-sized device.

6. The portable holder of claim 1, wherein the device holder is dimensioned to hold a tablet-sized device.

7. The portable holder of claim 1, wherein the straps are using one or more of: snaps, magnets, hook-and-loop fasteners, and buckles.

8. The portable holder of claim 1, wherein the extension arm is lockable at a desired length using one or more of: clamps, button clips, and lock pins.

9. The portable holder of claim 1, where the first rotatable joint and the second rotatable joint each provide at least a 180-degree range of motion.

10. The portable holder of claim 9, wherein the first rotatable joint and the second rotatable joint each provide a 360-degree range of motion.

11. The portable holder of claim 9, wherein at least one of the first rotatable joint and the second rotatable joint include a locking mechanism to inhibit the range of motion.

12. The portable holder of claim 1, where the extension arm is rotatable via the first rotation joint to lie flush with the body brace.

13. The portable holder of claim 1, wherein the extension arm and first rotatable joint are detachably coupled to the body brace.

14. The portable holder of claim 13, wherein the portable holder further comprises a tripod mount which is detachable couplable to the extension arm and first rotatable joint in place of the body brace.

15. The portable holder of claim 1, wherein the device holder is adjustable to accommodate different sizes of electronic devices.
